(19) United States
(12) Patent Application Publication
(10) Pub. No.: US 2020/0058435 A1
(43) Pub. Date: Feb. 20, 2020

(54) INDUCTOR STRUCTURE WITH HEIGHT LIMIT

(71) Applicant: MAG. LAYERS SCIENTIFIC-TECHNICS CO., LTD., Taoyuan City (TW)

(72) Inventors: Hsiu-Fa Yeh, Taoyuan City (TW); Pin-Yu Chen, Taoyuan City (TW); Hang-Chun Lu, Taoyuan City (TW); Ya-Wen Yang, Taoyuan City (TW); Chien-Chin Chang, Taoyuan City (TW); Yu-Ting Hsu, Taoyuan City (TW); Hung-Chih Liang, Taoyuan City (TW); Shih-Kai Huang, Taoyuan City (TW); Yen-Chun Wu, Taoyuan City (TW)

(21) Appl. No.: 16/104,137

(22) Filed: Aug. 17, 2018

(51) Int. Cl. H01F 27/26; H01F 27/29; H01F 27/02

(52) U.S. Cl. CPC H01F 27/263; H01F 1/14; H01F 27/02; H01F 27/29

(57) ABSTRACT

An inductor structure with height limit, which comprises: a conductor formed in a bent shape, and is set with a plurality of bending-portions, wherein a first connecting-pin and a second connecting-pin are respectively set at two ends of the conductor; a first magnetic core set with a first combining-surface, wherein the first combining-surface forms a concave groove to accommodate the conductor; and a second magnetic core set with a second combining-surface, wherein the second combining-surface forms a second concave groove to accommodate the conductor; wherein the second combining-surface is combined on the first combining-surface; wherein the conductor is sheathed and set between the first magnetic core and the second magnetic core, and is set with the first connecting-pin and the second connecting-pin exposedly. Therefore, the present invention can increase the magnetic (coupling) route length under the height limit to produce an effect of increasing the inductance value and current.

### (a) TECHNICAL FIELD OF THE INVENTION

The present invention relates to an inductor, and especially relates to an inductor structure with height limit.

### (b) DESCRIPTION OF THE PRIOR ART

Commonly, the inductor can be used for the choking, winding, high and low frequency signal filtering, or power conversion of transformer.

Therefore, one kind of an inductor is disclosed. Referring to FIG. 1, there is a magnetic-body assembly 10 and a substantially inverted U-shaped conductive plate 15. The magnetic-body assembly 10 includes a first magnetic body 11 and a second magnetic body 12 set above the first magnetic body 11.

The magnetic-body assembly 10 is set with a receiving groove 13 at the junction of the first magnetic body 11 and the second magnetic body 12 for receiving and penetrating the conductive plate 15 to set the magnetic-body assembly 10.

And, the bottom of the first magnetic body 11 is set with a terminal receiving groove 14. The two ends of the conductive plate 15 are respectively bent inwardly to form a terminal portion 16 for using as an end electrode of the inductor, and the terminal portion 16 of the conductive plate 15 is buried and stuck with the terminal receiving groove 14 to form the inductor.

In this technical solution, in order to improve the characteristics of the inductor, such as the inductance value and the current value, the inductor is usually designed to have a higher height (for example, the entire magnetic component 10), or is designed to have a longer length, thereby achieving the better characteristics of the inductor.

However, in modern electronic products, designing too high or too long inductor is contrary to the direction of its design (except for designing specific power capacity of the transformer), otherwise it should move toward volume reduction (especially height, too high will affect the thickness of the product). It is commonly applied for the inductors assembled and set in the Surface-Mount Technology (SMT).

### SUMMARY OF THE INVENTION

In view of the defects of conventional inductor, the object of the present invention is to develop an inductor that increases the magnetic (coupling) route length under the height limit.

To achieve the above object, the present invention provides an inductor structure with height limit, which comprises: a conductor formed in a bent shape, and the conductor is set with a plurality of bending-portions, wherein a first connecting-pin and a second connecting-pin are respectively set at two ends of the conductor; a first magnetic core set with a first combining-surface, wherein the first combining-surface forms a concave groove to accommodate the conductor; and a second magnetic core set with a second combining-surface, wherein the second combining-surface forms a second concave groove to accommodate the conductor; wherein the second combining-surface is combined on the first combining-surface; wherein the conductor is sheathed and set between the first magnetic core and the second magnetic core, and is set with the first connecting-pin and the second connecting-pin exposedly; wherein the first connecting-pin and the second connecting-pin respectively extend a first supporting-portion and a second supporting-portion; wherein the first magnetic core is made of an alloy material and the second magnetic core is also made of an alloy material.

Therefore, the present invention can increase the magnetic (coupling) route length under the height limit to produce an effect of increasing the inductance value and current.

Additionally, the present invention can also use a design way of stepping-stilts to elevate the height. Therefore, extra space can be left on the circuit board under the inductor of the present invention to accommodate and set other electronic components; which can save the circuit layout space of the circuit board and reduce the using area of the circuit board.

And, the magnetic core can use the alloy material to make the inductor of the present invention produce a low initial permeability (M) and the characteristic of high current to achieve the effect and object of the present invention.

### BRIEF DESCRIPTION OF THE DRAWINGS

FIG. 1 is a schematic diagram of the decomposition structure of the conventional inductor.

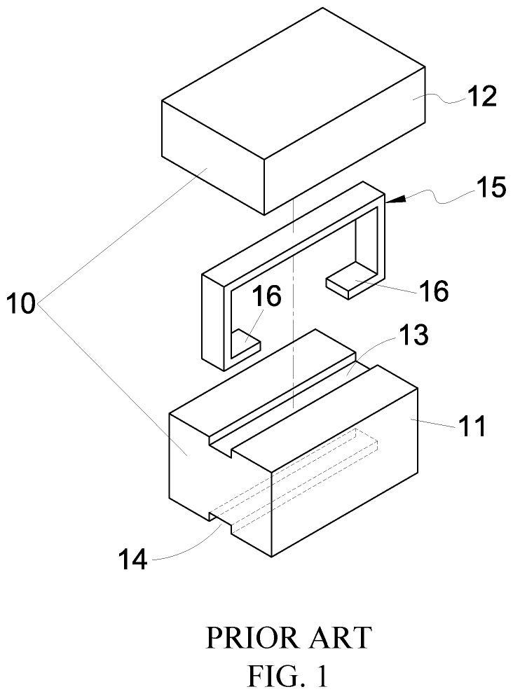

FIG. 2 is a schematic exploded view of the preferred embodiment of the present invention.

FIG. 3 is a schematic view of a three-dimensional combination structure of FIG. 2 of the preferred embodiment of the present invention.

FIG. 4 is a schematic exploded perspective view of another implementation form of the preferred embodiment of the present invention.

FIG. 5 is a schematic view of a three-dimensional combination structure of FIG. 4 of the preferred embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention. Various changes to the described embodiments may be made in the function and arrangement of the elements described without departing from the scope of the invention as set forth in the appended claims.

The foregoing and other aspects, features, and utilities of the present invention will be best understood from the following detailed description of the preferred embodiments when read in conjunction with the accompanying drawings.

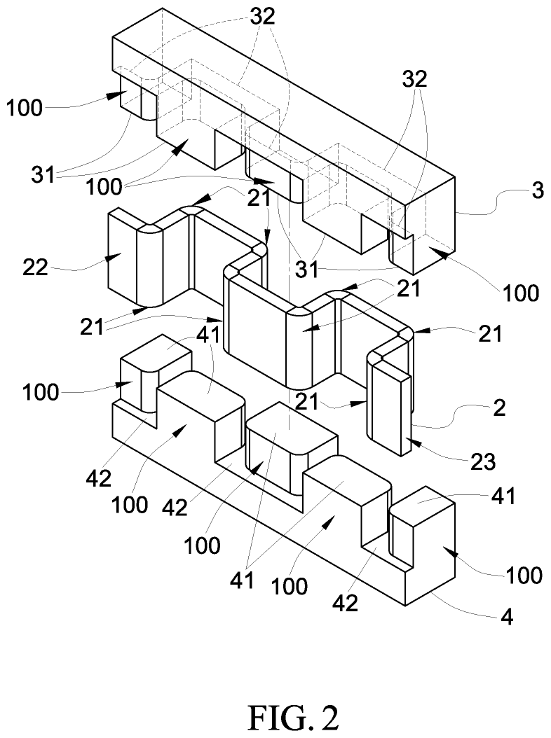

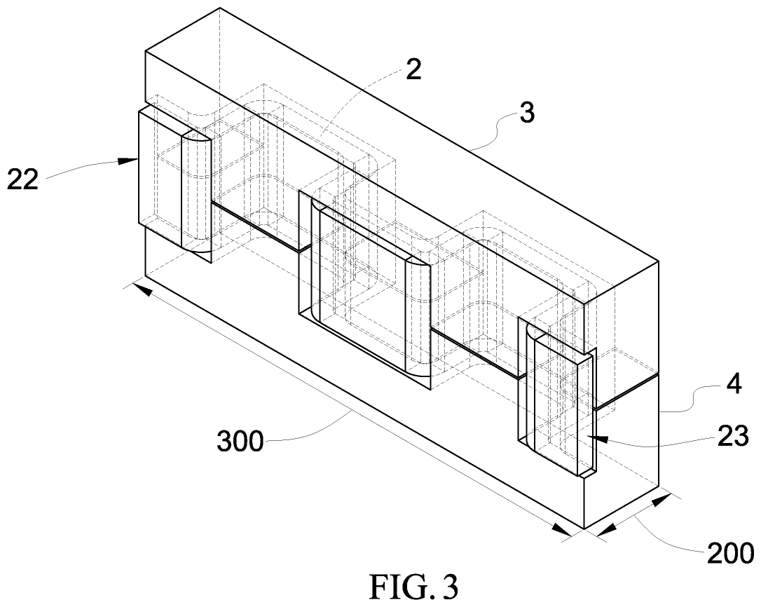

Please refer to FIG. 2 and FIG. 3, the present invention provides a height-limited inductor structure, which comprises: a conductor 2, a first magnetic core 3 and a second magnetic core 4.

The conductor 2 is formed in a bent shape, and the conductor 2 is set with a plurality of bending-portions 21 which can extend infinitely, not limited to the drawings, and two ends of the conductor 2 are respectively set with a first connecting-pin 22 and a second connecting-pin 23.

The first magnetic core 3 is set with a first combining-surface 31, whereon forms a concave groove 32 to accommodate the conductor 2. In the present embodiment, a plurality of pillar-bodies 100 are formed according to the bent shape of the conductor 2, and not limited to this.

The second magnetic core 4 is set with a second combining-surface 41, whereon forms a second concave groove 42 to accommodate the conductor 2 and the second combining-surface 41 is combined on the first combining-surface 31. The conductor 2 is sheathed and set between the first magnetic core 3 and the second magnetic core 4, and is set with the first connecting-pin 22 and the second connecting-pin 23 exposedly.

In this embodiment, the combining type between the conductor 2, the first magnetic core 3 and the second magnetic core 4 is adhered by an adhesive; the adhesive may be a thermosetting adhesive, a thermoplastic adhesive, a silicone adhesive, or the like, and not limited to this.

Therefore, please continue to refer to FIG. 3, which can make the present invention increases the magnetic (coupling) route length 300 under the height limit 200; it means that the inductance is extended and set from the horizontal direction. And, the cross-sectional area of the present invention becomes larger according to the principle of inductive energy storage, which produces an effect of increasing the inductance value and current; which is superior to the prior art and is the characteristic of the present invention.

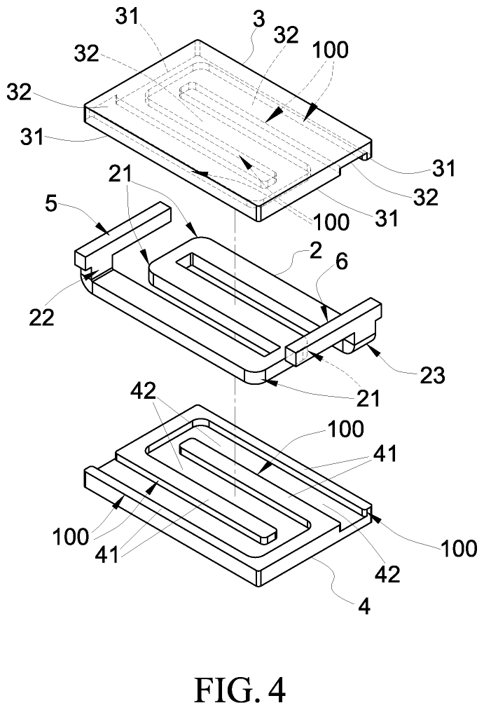

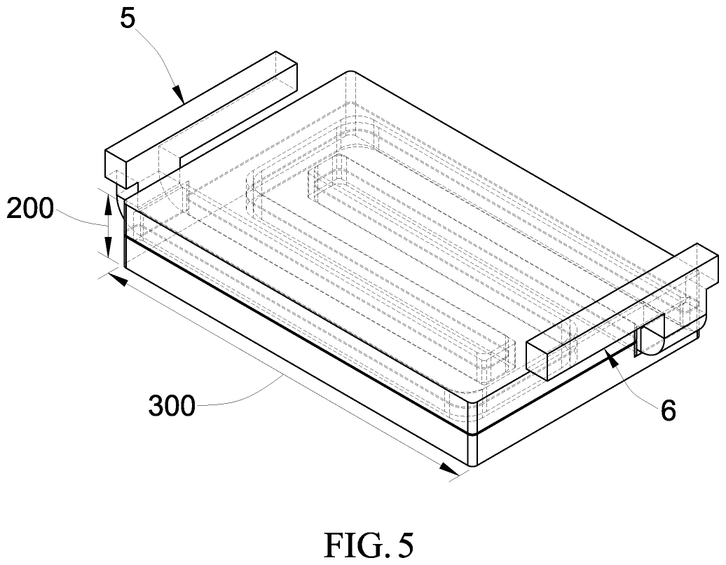

Furthermore, please further refer to FIG. 4 and FIG. 5, in addition to increasing the magnetic (coupling) route length 300 under the height limit 200 to increase the inductance value and current, this embodiment provides a similar and identical inductor, which the main differences are: The first connecting-pin 22 and the second connecting-pin 23 respectively extend a first supporting-portion 5 and a second supporting-portion 6. The first supporting-portion 5 and the second supporting-portion 6 can be symmetrically (interlacedly) set (as show in the figures), which can make the present invention elevate the height by using a design way of stepping-stilts. Therefore, extra space can be left on the circuit board under the inductor of the present invention to accommodate and set other electronic components (such as Integrated Circuit, IC); which can further save the circuit layout space of the circuit board and reduce the using area of the circuit board to achieve the effect and object of the present invention.

Further, when the first magnetic core 3 is made of an alloy material and the second magnetic core 4 is also made of an alloy material, which can cause the inductor of the present invention to have a low initial permeability (pi) and the characteristic of high current. It means that the present invention will produce a low initial permeability (μi) and the characteristic of high current when the magnetic core is made of an alloy material.

In this embodiment, the alloy material can use any material such as iron, cobalt, nickel, aluminum, gold, silver, copper, tin, titanium, molybdenum, chromium, lanthanum, tungsten, lanthanum, cerium, magnesium, zinc, manganese, and lithium as a main component, for example, an aluminum alloy, a magnesium alloy, a lithium alloy, or the like.

I claim:

1. an inductor structure with height limit, which comprises:
a conductor formed in a bent shape, and the conductor is set with a plurality of bending-portions, wherein a first connecting-pin and a second connecting-pin are respectively set at two ends of the conductor;
a first magnetic core set with a first combining-surface, wherein the first combining-surface forms a concave groove to accommodate the conductor; and
a second magnetic core set with a second combining-surface, wherein the second combining-surface forms a second concave groove to accommodate the conductor;
wherein the second combining-surface is combined on the first combining-surface;
wherein the conductor is sheathed and set between the first magnetic core and the second magnetic core, and is set with the first connecting-pin and the second connecting-pin exposedly.

2. The inductor structure with height limit according to claim 1, wherein the first connecting-pin and the second connecting-pin respectively extend a first supporting-portion and a second supporting-portion.

3. The inductor structure with height limit according to claim 1, wherein the first magnetic core is made of an alloy material and the second magnetic core is also made of an alloy material.
